(19) United States
(12) Patent Application Publication
(10) Pub. No.: US 2014/0211862 A1
(43) Pub. Date: Jul. 31, 2014

(54) USB ISOLATOR INTEGRATED CIRCUIT WITH USB 2.0 HIGH SPEED MODE AND AUTOMATIC SPEED DETECTION

(71) Applicant: The Silanna Group Pty Ltd, Eight Mile Plains, Queensland (AU)

(72) Inventors: Yashodhan Vijay Moghe, Marsfield (AU); James Brinkhoff, Meadowbank (AU)

(73) Assignee: The Silanna Group Pty Ltd., Eight Miles Plains, QLD (AU)

(21) Appl. No.: 14/119,855

(22) PCT Filed: May 25, 2012
(86) PCT No.: PCT/AU2012/000588

§ 371 Date: Jan. 21, 2014

Related U.S. Application Data
(60) Provisional application No. 61/489,977, filed on May 25, 2011.

(51) Int. Cl. H04B 5/00

(52) U.S. Cl. CPC H04B 5/005; H04B 5/0012
USPC 375/256

(57) ABSTRACT

A USB isolator integrated circuit, including:
an isolation barrier disposed between an upstream portion and a downstream portion of the integrated circuit to provide galvanic isolation therebetween;
a first USB 2.0 interface configured to receive and transmit USB 2.0 compliant signals between the upstream portion of the integrated circuit and an upstream USB entity;
a second USB 2.0 interface configured to receive and transmit USB 2.0 compliant signals between the downstream portion of the integrated circuit and a downstream USB entity;
a plurality of signal coupling components configured to allow communication between the upstream portion and the downstream portion of the integrated circuit to allow the upstream USB entity and the downstream USB entity to communicate therebetween using a USB 2.0 protocol while maintaining the galvanic isolation therebetween; and
   the upstream and downstream portions of the integrated circuit including respective modules configured to automatically detect a USB 2.0 speed of the upstream or downstream USB entities and responsive to said detection to automatically put the integrated circuit into a corresponding one of a plurality of USB 2.0 speed modes for communication between the upstream and downstream USB entities, the plurality of USB 2.0 speed modes including a USB low-speed mode, a USB full-speed mode, and a USB 2.0 high-speed mode.

### TECHNICAL FIELD

The present invention relates to an isolator integrated circuit that provides galvanic isolation between two regions of the integrated circuit while transferring USB 2.0 data between those regions in both directions.

### BACKGROUND

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Universal Serial Bus, or ‘USB’, is a ubiquitous standard for transferring data between USB entities such as USB hosts, USB devices, and USB hubs. USB 2.0 supports data transfer rates of up to 480 Mbps.

The transmission of USB signals across an electrical isolation barrier is important for many applications, including:
(i) mains connected medical equipment (for patient safety);
(ii) communications links across cables between mains connected equipment (to avoid ground loops);
(iii) mains data networks (for mains power isolation);
(iv) precision audio, sensing and data acquisition (to suppress noise pickup);
(v) industrial sensing and control (for isolation of various power domains); and
(vi) automotive circuits (for protection from high voltage electrical spikes).

USB 2.0 supports three signaling rates: a “low-speed” rate of 1.5 Mbps, a “full-speed” rate of 12 Mbps, and a “high-speed” rate of 480 Mbps.

Prior art USB isolators have traditionally used optocouplers to provide the galvanic isolation. However, optocouplers can support only relatively low data rates (˜10 Mbps) and consume a lot of power (>10 mW). Recently, Analog Devices, Inc. introduced the ADUM4160 full/low-speed USB digital isolator, which is an integrated circuit with transformer-based isolation, as described at http://www.analog.com/en/interface/digital-isolators/adum4160/products/product.html. However, the ADUM4160 does not support the USB 2.0 high-speed mode, and is thus limited to 12 Mbps. Additionally, the ADUM4160 is incapable of automatic speed detection, and the selection of speed must be manually set using explicit pins (SPU and SPD) of the ADUM4160 package.

It is desired to provide a USB isolator integrated circuit that alleviates one or more limitations of the prior art, or at least provides a useful alternative.

### SUMMARY

In accordance with the present invention, there is provided a USB isolator integrated circuit, including:

an isolation barrier disposed between an upstream portion and a downstream portion of the integrated circuit to provide galvanic isolation therebetween;

a first USB 2.0 interface configured to receive and transmit USB 2.0 compliant signals between the upstream portion of the integrated circuit and an upstream USB entity;

a second USB 2.0 interface configured to receive and transmit USB 2.0 compliant signals between the downstream portion of the integrated circuit and a downstream USB entity;

a plurality of signal coupling components configured to allow communication between the upstream portion and the downstream portion of the integrated circuit to allow the upstream USB entity and the downstream USB entity to communicate therebetween using a USB 2.0 protocol while maintaining the galvanic isolation therebetween; and

the upstream and downstream portions of the integrated circuit including respective modules configured to automatically detect a USB 2.0 speed of the upstream or downstream USB entities and responsive to said detection to automatically put the integrated circuit into a corresponding one of a plurality of USB 2.0 speed modes for communication between the upstream and downstream USB entities, the plurality of USB 2.0 speed modes including a USB low-speed mode, a USB full-speed mode, and a USB 2.0 high-speed mode.

In some embodiments, the modules include state machines respectively disposed on the upstream and downstream portions of the integrated circuit, the state machines being configured to store state information representing states of the respective portions of the integrated circuit and to synchronise state information therebetween.

In some embodiments, the state machines are further configured to correct one or more errors in the states of the upstream and/or downstream portions of the integrated circuit.

In some embodiments, USB data is communicated between the upstream and downstream USB entities over one or more of the signal coupling components, and the state machines communicate the state information therebetween over one or more other ones of the signal coupling components.

In some embodiments, the one or more other signal coupling components communicating the state information between the upstream and downstream portions of the integrated circuit are not inline with the one or more signal coupling components over which the USB data is communicated.

In some embodiments, the one or more other signal coupling components communicating the state information are clocked independently of and slowly relative to the one or more signal coupling components over which the USB data is communicated.

In some embodiments, only one of the upstream and downstream portions of the integrated circuit includes an input from a crystal oscillator to function as a reference for a PLL, the output of which is used to resynchronize USB high-speed signaling before retransmission onto a USB bus on the corresponding portion of the integrated circuit.

In some embodiments, the upstream and downstream portions of the integrated circuit each includes a corresponding input from a corresponding crystal oscillator to function as a reference for a corresponding PLL, the output of which is used to resynchronize USB high-speed signaling before retransmission onto the corresponding USB bus on the corresponding portion of the integrated circuit.

In some embodiments, the signal coupling components are capacitive isolators that provide capacitive coupling between the upstream and downstream portions of the integrated circuit.

In some embodiments, the capacitive isolators include capacitors and capacitor charging components configured to refresh charges on the capacitors.

In some embodiments, the upstream and downstream portions of the integrated circuit are mutually spaced on a single electrically insulating die and the integrated circuit includes at least one coupling region on the die to provide capacitive coupling between the otherwise mutually isolated integrated circuit portions, the integrated circuit portions being formed by a plurality of layers on the single die, the layers including metal and dielectric layers and at least one semiconductor layer; wherein at least one of the dielectric layers extends from the integrated circuit portions across the coupling region and at least a corresponding one of the metal layers and/or at least one semiconductor layer extends from each of the integrated circuit portions and partially into the coupling region to form one or more capacitors therein and thereby provide the capacitive coupling between the galvanically isolated integrated circuit portions.

In some embodiments, each of said upstream and downstream portions of the integrated circuit includes a corresponding input for coupling to a corresponding precision resistor to define currents for high speed USB 2.0 signaling.

In some embodiments, the first USB 2.0 interface is configured to receive and transmit USB 2.0 compliant signals between the upstream portion of the integrated circuit and any USB entity, including: a standard USB host, a USB Embedded Host, a USB On-The-Go device, and a USB hub; and the second USB 2.0 interface is configured to receive and transmit USB 2.0 compliant signals between the downstream portion of the integrated circuit and any USB entity, including: a standard USB device, a USB Embedded Host, a USB On-The-Go device, and a USB hub.

In the described embodiments, the modules are configured to propagate USB signals, device connects and device disconnects from one of the upstream and downstream USB entities to the other of the upstream and downstream USB entities so that the USB isolator integrated circuit is transparent to the upstream and downstream USB entities other than time delays.

In some embodiments, at least some of the signal coupling components are bi-directional signal coupling components configured to allow communication in both directions between the upstream portion and the downstream portion of the integrated circuit.

In some embodiments, the signal coupling components include first uni-directional signal coupling components configured to allow communication only from the upstream portion to the downstream portion of the integrated circuit, and second uni-directional signal coupling components configured to allow communication only from the downstream portion to the upstream portion of the integrated circuit.

### BRIEF DESCRIPTION OF THE DRAWINGS

Some embodiments of the present invention are hereinafter described, by way of example only, with reference to the accompanying drawings, wherein:

FIG. 1 is a simplified block diagram of an embodiment of a USB isolator die or chip;

FIGS. 2 and 3 are schematic timing diagrams showing the various signals in the USB isolator for a start of packet and end of packet, respectively, in USB full speed mode;

FIGS. 4 and 5 are schematic timing diagrams showing the various signals in the USB isolator for a start of packet and end of packet, respectively, in USB high speed mode;

FIG. 6 is a schematic timing diagram showing various signals in the isolator during high speed mode connection and reset;

FIG. 7 is a schematic timing diagram showing various signals in the isolator during entry to suspend mode from high speed states;

FIGS. 8 and 9 are schematic timing diagrams showing various signals in the isolator during device disconnect detection and indication in high speed and full speed modes, respectively, for cases where data is received from an upstream USB entity;

FIG. 10 is a schematic circuit diagram showing components for refreshing the state of an un-driven capacitive bi-directional isolation channel, where the two sides of the isolation channel are denoted ‘a’ and ‘b’, ‘pu’ means pull-up, and ‘pd’ means pull down;

FIG. 11 is a simplified circuit diagram of the high speed part of an embodiment of a USB isolator chip with PLL synchronization, where a crystal oscillator is connected to the upstream side of the chip, and a PLL on that side is used for resynchronization and data recovery on both sides; and

FIG. 12 is a simplified block diagram of a further embodiment of a USB isolator die or chip.

### DETAILED DESCRIPTION

Described herein are USB isolators that provide electrical isolation between two power domains while transferring data across the isolation barrier between the power domains in accordance with the USB 2.0 standard. The USB isolators are in the form of an integrated circuit on a single chip or die, and fully support the three USB 2.0 speed modes of low speed, full speed and high speed. The isolators do not require the USB speed mode to be hardwired, but automatically detect the speed of attached USB 2.0 hosts and peripherals, and consequently appear transparent to upstream and downstream USB entities, except for a short additional delay. The USB isolators can be included within the housing of a USB entity (e.g., a USB device, host, or hub), or external thereto; for example, a USB isolator as described herein can be integrated into a USB cable or other form of USB interconnect.

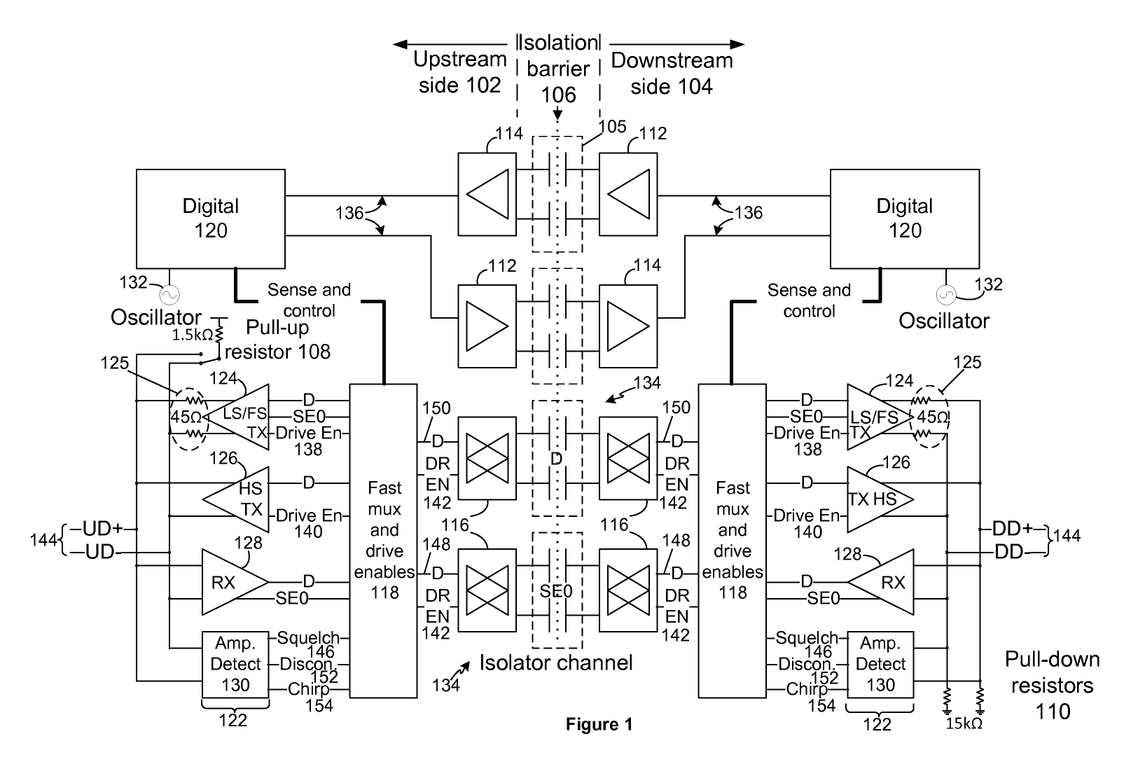

As shown in schematic form in the example isolator of FIG. 1, the USB isolators described herein are in the form of an integrated circuit that defines at least two mutually isolated power or electrical domains 102, 104 coupled for communication therebetween by coupling components 105. In the embodiment of FIG. 1, the power domains 102, 104 are constituted by upstream (US) 102 and downstream (DS) 104 portions of an integrated circuit mutually spaced on a single die or substrate, and at least one isolation barrier 106 disposed between the two portions 102, 104 provides the galvanic isolation therebetween. The coupling components 105 allow communication of information across the isolation barrier 106 between the upstream and downstream portions of the integrated circuit whilst maintaining the galvanic isolation therebetween.

In general, the coupling components 105 may use any suitable form of coupling, including capacitive, inductive, or optical coupling, although the specific embodiments described herein use capacitive coupling. In particular, the capacitive coupling can be provided by integrated capacitor structures such as those described in U.S. Patent Application No. 61/415,281, and in PCT/AU2011/001497, both entitled Single-Chip Integrated Circuit with Capacitive Isolation, is the entirety of each application being incorporated herein by reference. Briefly, in such embodiments at least one metal layer and/or at least one semiconductor layer extends from each of the upstream and downstream portions 102, 104 and partially across the isolation barrier 106. The extending portions of these conductive layers are arranged to be electromagnetically coupled through at least one dielectric material to form one or more capacitors across the isolation barrier 106 and thereby provide capacitive coupling between the upstream and downstream portions 102, 104 of the integrated circuit. However, it will be apparent to those skilled in the art that many other types and/or configurations of coupling components could be used to couple the integrated circuit portions 102, 104 in other embodiments.

With the exception of pull-up and pull-down resistors 108, 110, and control switches for the pull-up resistor 108, whose roles are described above, the upstream and downstream power domains 102, 104 include the same components, including:
(i) isolation transmitters 112, receivers 114, and transceivers 116 that respectively transmit, receive, and transmit/receive data across the coupling components 105;
(ii) a fast multiplexer and drive enable signal generator (FMUX) 118 that controls the direction of data transmission between the upstream (US) and downstream (DS) sides of the USB isolator;
(iii) a digital logic block 120 that controls the state of all of the circuits on the corresponding power domain and synchronizes the state with that of the other power domain; and
(iv) a USB line transceiver 122 that indicates the status of a USB interface, and contains all the circuitry necessary to transmit and receive data on the USB data cables, including: LS/FS and HS transmitters/line drivers 124, 126, a LS/FS/HS receiver 128, amplitude detectors 130. The LS/FS/HS receiver 128 is always enabled.

In addition, the integrated circuit includes the following auxiliary subsystems that are not shown in the simplified block diagram of FIG. 1:
(i) A linear regulator, which is continuously enabled and produces the required circuit supply voltage from the USB bus voltage. Alternatively, if the required circuit supply voltage is supplied externally, the regulator stays enabled but does not affect the external supply.
(ii) Voltage and current generator circuitry that generates the precision voltages and currents required for detecting the various states of the USB bus, and for driving the USB bus with the correct signaling conditions. An optional off-chip precision resistor is used if high-speed mode needs to be supported, which allows higher accuracy definition of drive current and hence voltage. The resistor can be omitted for applications only requiring low speed and full speed modes.
(iii) An oscillator 132 for clocking the digital logic block 120.

By way of background to the following description, the reader is referred to the USB 2.0 standard, or at least to the summary provided by Wikipedia at http://en.wikipedia.org/wiki/Universal_Serial_Bus. As described in those documents, USB 2.0 is a half-duplex, differential signaling protocol that transmits signals on a twisted-pair data cable, where the two wires of the twisted pair carry respective digital signals referred to in the art as D+ and D−, respectively.

A USB connection can generally be considered to be between an upstream USB entity (e.g., a USB host) and a downstream USB entity (e.g., a USB device). A USB upstream entity includes 15 kΩ pull-down resistors on the two data lines so that these lines are pulled low when no downstream entity is connected, a state referred to as “single-ended zero” or SE0. In contrast, USB downstream entities include a 1.5 kΩ pull-up resistor on one of the data lines so that when a downstream entity is connected to a USB cable in the SE0 state, one of the USB data lines is pulled high. Full-speed downstream USB entities pull the D+ line high, whereas low-speed downstream USB entities pull the D− line high. Once the speed has been established, USB data is then communicated between the upstream and downstream entities by toggling the data lines between two states referred to in the art as J and K states, these being opposite states wherein a corresponding one of the data lines is in a high voltage state and the other data line is in a low voltage state.

The USB 2.0 protocol thus defines three states: J, K, and SE0, as follows: {D+ high and D− low}, {D+ low and D− high}, and {D+ low and D− low}. However, in the described embodiments where the isolation is capacitive, a single digital isolation channel is only capable of sending two electrical states (e.g., representing J and K states), and consequently, in the absence of signal multiplexing, two independent isolation channels are used to send the 3 possible USB states. Although the two isolation channels could be configured to correspond directly to the two USB data cables (i.e., with one channel representing the D+ signals, and the other the D− signals), in the described embodiments, one channel carries D information (the result of subtracting D− from D+), and the other represents SE0. When the SE0 channel is asserted, the D channel is ignored.

USB is a bi-directional protocol, and the signaling could be accomplished using four uni-directional isolation channels, two for each direction. However, the described embodiments use two bi-directional isolation channels 134 that carry the D and SE0 signals, respectively. Each of the isolator transceivers 116 on each side of the coupling components 105 has a drive enable input (DR_EN). When this is asserted, that side of the corresponding channel 134 has control of the channel 134 and is able to drive information to the other side. When neither side is transmitting, the capacitor voltages on channels 134 remain those of their previous driven states, and both sides wait for a transmission from the other side, or for a command to transmit to the other side.

### The Digital Logic Circuit 120 and State Synchronization

Support for the low speed and full speed modes of USB 2.0 is relatively simple and does not require significant digital logic control. However, the complexity of supporting the USB 2.0 high speed protocol across an isolation barrier requires additional intelligence to control the operation of the isolator channels 134 and the USB drivers and receivers 124, 126, 128. This takes the form of a digital logic block 120 on each of the upstream 102 and downstream 104 sides of the isolator. The digital logic blocks 120 each include a state machine and synchronize the isolator states on the upstream 102 and downstream 104 sides.

In the described embodiments, the states of the isolator include:
Downstream entity disconnected
LS idle
LS TX DS to US
LS TX US to DS
LS suspend
LS wakeup
LS reset
FS idle
FS TX DS to US
FS TX US to DS
FS suspend
FS wakeup
FS reset
FS chirp
HS idle
HS TX DS to US
HS TX US to DS
HS suspend
HS wakeup
HS reset

However, other states and/or combinations of states may be used in other embodiments.

The transitions from one state to another are divided into two categories: fast and slow. The fast state transitions are those going from idle to transmit (TX) states and vice versa. In order to reduce power consumption, the digital logic blocks 120 are clocked at a relatively low frequency, and thus cannot handle these fast transitions. The fast transitions are detected and controlled by the fast multiplexer and drive enable blocks (FMUX) 118 described below. However, the digital logic block 120 is made aware of these state transitions, and monitors to ensure there has not been an error in states, such as might be caused, for example, by power supply or ground transients. This is accomplished through the digital logic blocks 120 having inputs connected to all the digital outputs of the FMUX 118, the receiver 128 and the amplitude detectors 130. For the sake of clarity, these connections are not shown in the simplified block diagram of FIG. 1. The logic blocks 120 are able to override and correct the state of the fast multiplexer and drive enable blocks 118 via separate control pins if an error occurs.

To facilitate the synchronization and state communication between the upstream 102 and downstream 104 sides of the chip, one or more additional isolation channels 136 are provided. These additional isolator channels 136 allow each of the two sides 102, 104 to transmit its current state to the other side. Each side is thereby made aware of the state on the other side and can update its own current state if necessary. Errors due to power supply or signal glitches or common mode transients can be detected and corrected by this mechanism. The embodiment shown in FIG. 1 uses two uni-directional isolators to exchange state information between the upstream to downstream sides. However, it will be apparent that a single bi-directional channel could be used in other embodiments.

The state information is sent across the isolation channels 136 using a serial protocol to reduce the number of isolation channels required and hence chip area. An 8-bit packet, for example, allows sending up to 128 commands (with the first bit of the packet used as a start-of-packet indicator). As shown in the embodiment of FIG. 1, the packets can be sent across asynchronously, with no explicit clock, to reduce the number of isolation channels needed, although this may not be the case in other embodiments. In some embodiments, the isolator uses a simple burst-mode clock and data recovery circuit, as described in M. Banu and A. E. Dunlop, “Clock Recovery Circuits With Instantaneous Locking,” Electronics Letters, November 1992, Vol. 28, No. 23, Pg. 2128-2130. However, in some embodiments do not require a reference PLL, because the oscillators on both sides of the chip are selected to have similar frequencies matching their measured characteristics. The approximate data rate at the receiving side is set by the clock 132 used by the digital logic block 120. This is selected to have a sufficiently similar frequency to the corresponding clock on the transmitting side, and with sufficient frequency accuracy to recover a string of bits with no transitions correctly. The maximum length of such a string is dictated by the frequency matching of the oscillators 132 on the two sides of the chip. Alternatively, an encoding scheme with guaranteed transitions can be used, such as Manchester encoding.

In other embodiments, where a required frequency tolerance between the oscillators 132 on the two sides 102, 104 of the chip cannot be guaranteed, a slower serial encoding scheme can be used. For example, in some embodiments, the two sides 102, 104 of the chip communicate using a coding scheme that encodes the serial data stream using different time intervals between successive pulses to represent logic ‘0’ and logic ‘1’ states. Each packet includes a header with an example ‘0’ and ‘1’ so that the receiver can determine the timing thresholds to determine the difference between ‘0’ and ‘1’ bits. Such a scheme is useful in embodiments where the integrated circuit is manufactured using semiconductor processes where there are (or may be) temperature or supply voltage differences between the two sides 102, 104 of the chip that cause a substantial mismatch in the frequencies of the respective oscillators 132.

Disconnect, reset and resume signaling are slow, and are handled by the digital logic blocks 120.

### The Fast Multiplexer and Drive Enable Circuit (FMUX) 118

Since the transitions from idle states to transmit states are fast and the isolator should not distort the width of any pulses, the digital logic block 120 is not placed in-line with the data/SE0 channels 134 because the digital logic block 120 is clocked slowly. However, a mechanism is nevertheless required to enable the drive controls for the isolator data channels 134 when a transmission is detected, and to enable the USB bus transmitters 124, 126 when data is received from the other side of the isolator chip. These signals need to be closely aligned to the data in order to avoid ‘glitches’ and pulse width distortion.

These features are provided by the fast multiplexer and drive enable circuit block (FMUX) 118, which is arranged in line with the data (D) and SE0 lines 134. The FMUX block 118 receives signals from the digital logic block 120 that indicate the current speed mode (low, full or high speed), and, in response to these signals, switches the data signals from/to the appropriate USB line drivers and receivers 124, 126, 128. The FMUX block 118 also provides the drive enable signals 138, 140 for the LS/FS and HS transmitters 124, 126, and the drive enable signals 142 for the data isolation channels 134. These drive enable signals 138, 140, 142 generated by the FMUX 118 can be overridden by the digital logic block 120 if needed; for example, if a state mismatch between the two sides 102, 104 of the chip has occurred. In addition, the overrides allow the digital logic blocks 120 to control the outputs of the FMUX 118 in states that do not require fast transitions, such as the disconnect, reset, suspend, and resume states, and during speed detection.

### Alternate Signaling Arrangements Across the Isolation Barrier

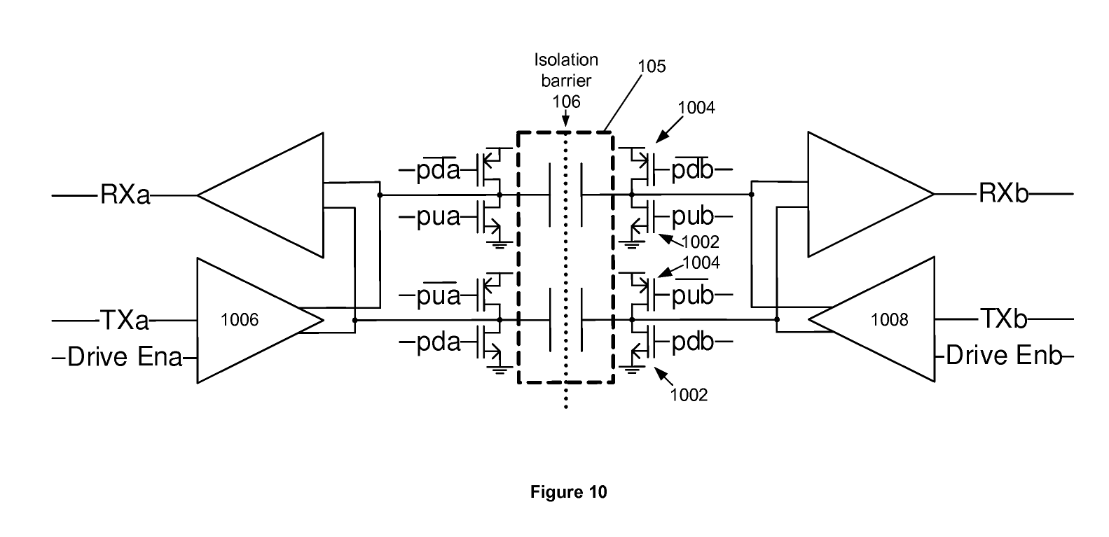

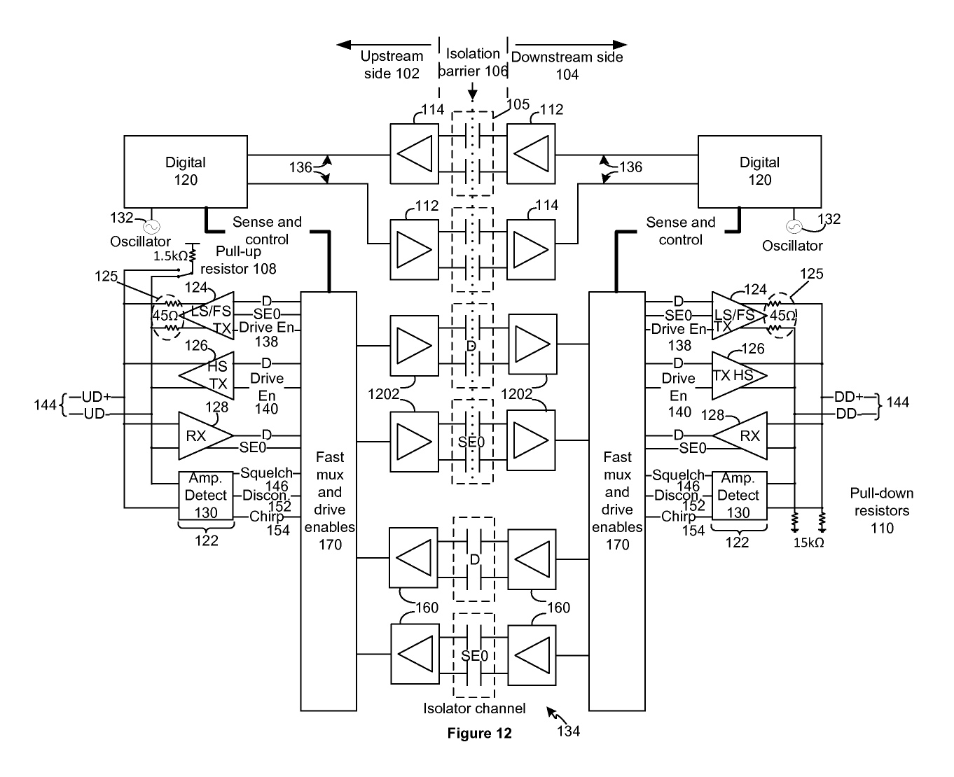

The embodiment shown in FIG. 1 uses bidirectional digital isolators 105 to reduce the required chip area. In some embodiments, unidirectional digital isolators (which may or may not be capacitive) 1202 are used to convey all signals across the isolation barrier 106, as shown in FIG. 12. This arrangement consumes more chip area but simplifies the design in two ways: (i) the FMUX 180 block does not need to provide drive enable signals to the isolator side, and (ii) the isolator refresh circuitry described below and shown in FIG. 10 can potentially be removed.

It will be apparent to those skilled in the art that many variations on signaling arrangements across the isolation barrier 106 are possible in other embodiments, including:
(i) using non-capacitive isolation elements, for example inductive coupling or Giant Magnetoresistance Ratio (GMR) elements;
(ii) using redundant or additional signals across the isolation barrier 106 to correct errors or transmit DC information (for example, using two pairs of capacitors per isolator channel, where one pair carries the fast data signal and the other pair carries a clock signal modulated by the data);
(iii) combining the transmitters 112 and receivers 114 for the state synchronisation signals 136 into bi-directional transceivers to reduce die area; and
(iv) encoding the content of the data or control signals across the isolation barrier 108 to detect or correct errors and glitches (e.g., the use of parity bits, preamble sequences, CRC checks or handshaking procedures known in the field of digital communications).

### Low and Full Speed Modes—Start of Packet

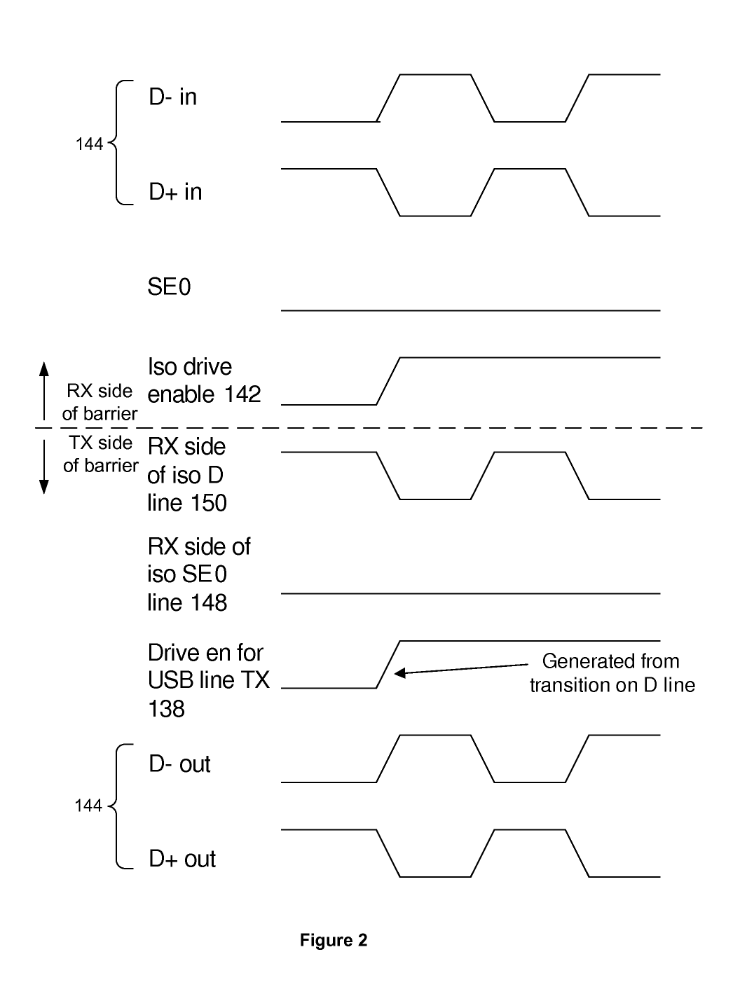

Returning to the embodiment shown in FIG. 1, FIG. 2 is a schematic timing diagram showing the various signals in full speed mode for a start of packet. In low speed and full speed modes, the only difference from the perspective of the FMUX 118 is whether D+ is high for a J or for a K symbol. In these two lower speed modes, as soon as the FMUX 118 detects an edge in the D signal received from the USB line receiver 128, indicating the start of a packet, the FMUX 118 asserts the isolator channel drive enables 142, and the received USB data is sent across the isolation data D channel 134.

On the other side of the isolation barrier 106, when a transition is indicated from the isolator transceiver 116, the FMUX 118 on that side asserts the drive enable signal 138 for the LS/FS USB line driver 124, which sends the data received from the isolator channels 134 onto the USB bus 144.

### Low and Full Speed Modes—End of Packet

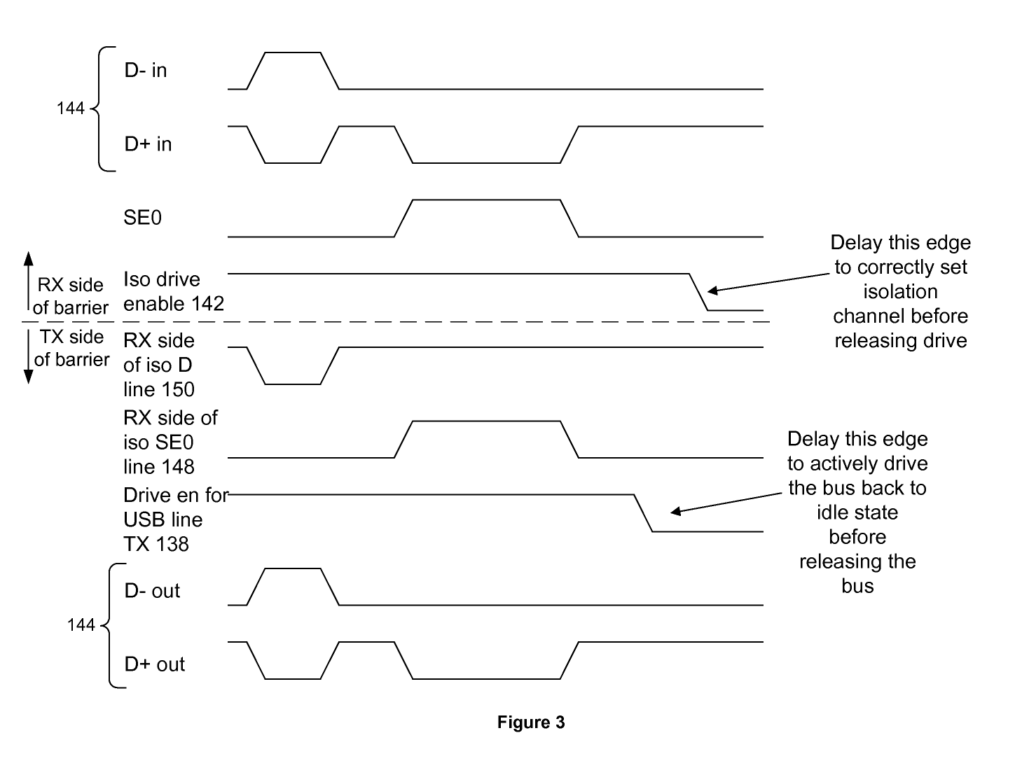

FIG. 3 is a schematic timing diagram showing the various signals in full speed mode for an end of packet. The isolation channel drive enable signal 142 is released after an SE0 is generated by the USB receiver 128, followed by a return to a J (low/full speed end of packet). In embodiments where the coupling across the isolation barrier 106 is provided by capacitive coupling components, a short delay, of the order of 1 bit time is introduced before releasing the isolator drive enables 142 in order to ensure that the isolation channels 134 are charged to the correct levels before being released.

On the other side of the isolation barrier 106, when the SE0 isolator channel is asserted, this is also sent onto the USB bus 144, and the FMUX 118 waits for a return to the J state. Following this, the USB line driver drive enable signal 138 is released, so the USB bus 144 is released.

### High Speed Mode—Start of Packet

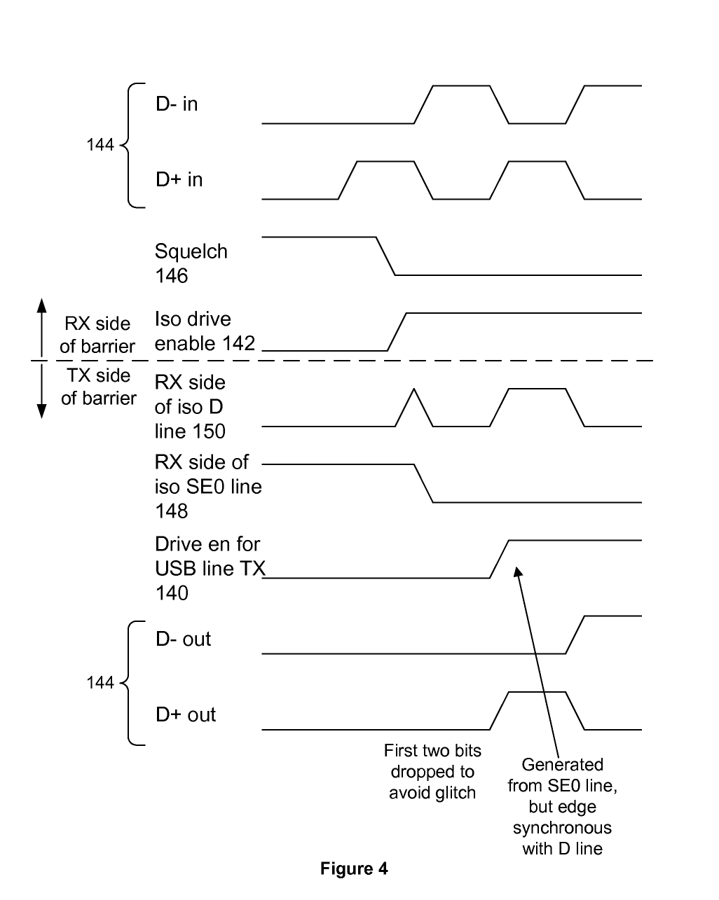

FIG. 4 is a schematic timing diagram showing the various signals in high speed mode for a start of packet. When the FMUX 118 high speed mode input (not shown) is asserted, a departure of the USB bus 144 from the USB idle state is indicated by an edge on the D+/D− lines 144. This is detected by one of the amplitude detectors 130—specifically a squelch detector, the output of which 146 goes low when the input differential amplitude on the USB lines 144 exceeds a predefined threshold. The FMUX 118 on the side of the chip that is receiving data from the USB bus 144 will then assert the corresponding isolator channel drive enables 142, and send the received data across the isolation barrier data (D) channel.

On the other side of the isolation barrier in high speed mode, a start of packet is indicated by the SE0 isolation channel output 148 going low. In order to avoid a glitch on the first bit due to the delay of the squelch detector, the first transition on the isolator data line 150 is discarded. From the second transition, the drive enable signal 140 for the high speed USB line driver 126 is asserted, and the data is sent out onto the USB bus 144.

### High Speed Mode—End of Packet

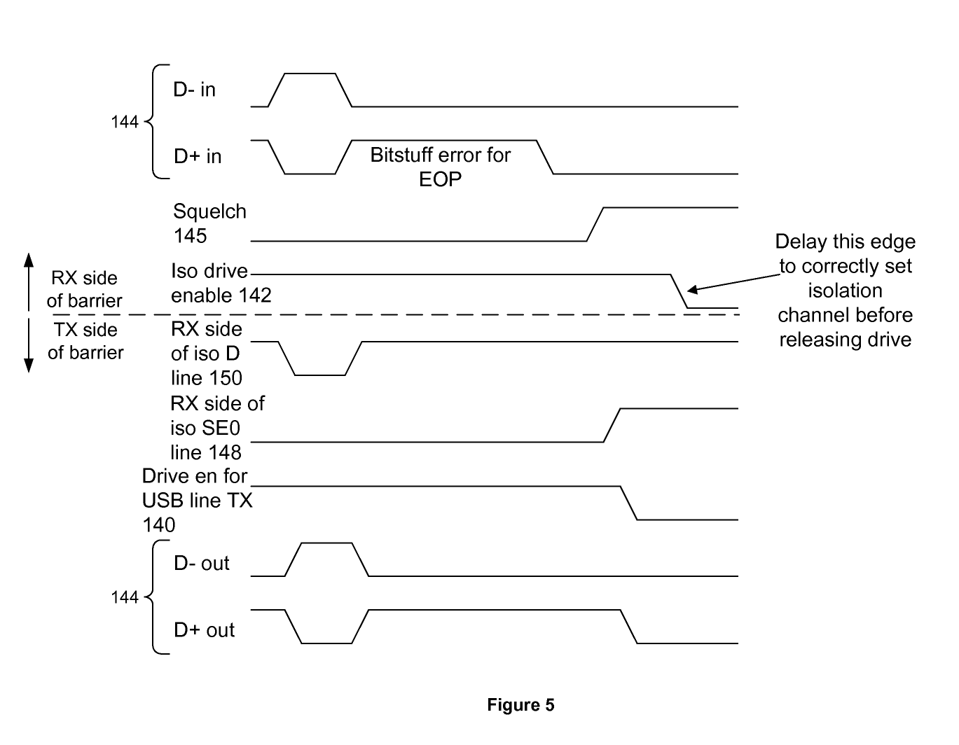

FIG. 5 is a schematic timing diagram showing the various signals in high speed mode for an end of packet. When the USB bus 144 returns to the idle state, the squelch detector output 146 is re-asserted. The FMUX 118 will then release the isolator channel drive enables 142. In embodiments where the coupling across the isolation barrier 106 is provided by capacitive coupling, a short delay of approximately a bit time is introduced before releasing the isolator drive enables 142, in order to ensure that the isolation channels 134 are charged to the correct levels before being released.

On the other side of the isolation barrier 106 in high speed mode, the end of packet is recognized when the SE0 isolator channel output 148 goes high again. The FMUX 118 then releases the high speed driver drive enable 140, so the USB bus 144 returns to the idle state.

### Speed Detection, Speed Indication, and Signaling

The isolators described herein allow automatic detection of each of the three USB 2.0 speed protocols, including high speed.

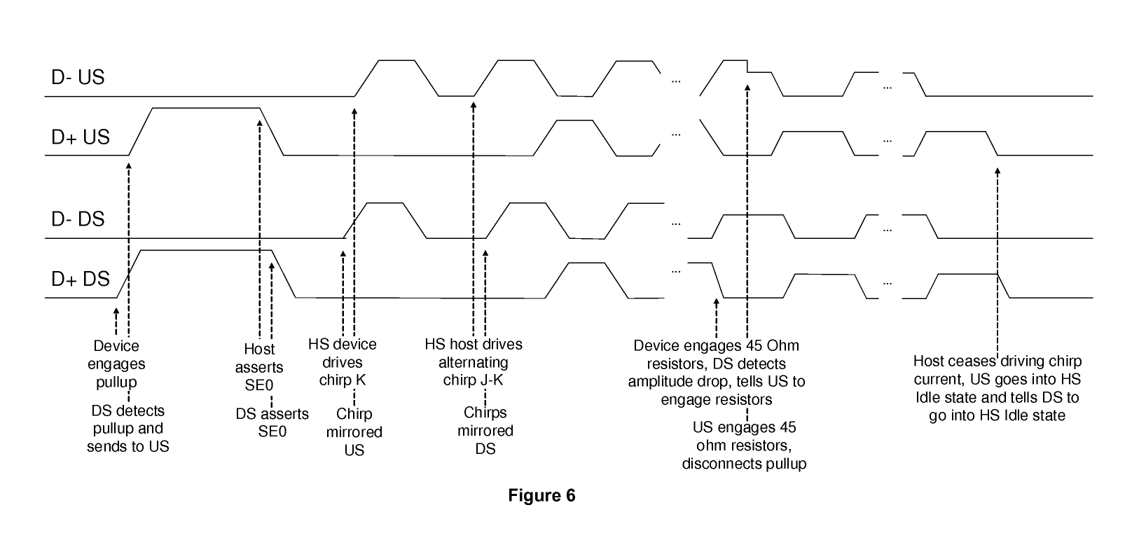

FIG. 6 is a schematic timing diagram showing various signals in the isolator during high speed detection. When a USB entity is first connected to the downstream side 104 of the USB isolator, its pull up resistor pulls either the DD+ or DD− high, indicating whether it is capable of full speed signaling or is limited to low speed signaling, as described above. The receiver 128 of the downstream side 104 detects the states of these USB bus lines 144, and via the downstream FMUX 118 and the state machines of the two digital logic blocks 120, the upstream digital block 120 connects the upstream side pull up resistor 108 to the corresponding USB line on the upstream side 102 of the chip. This indicates the speed of the downstream USB entity to the upstream USB entity, thereby making the USB isolator chip appear transparent.

The high speed mode is detected as follows. If full speed mode was indicated, then after the upstream USB entity initiates a reset condition, the USB isolator waits for the downstream entity to send its single chirp. If this is detected, it is sent to the upstream side 102 of the chip, and output with the LS/FS driver 124 disabled, pull-up resistor 108 connected, and by driving the high speed signaling current into the appropriate one of the USB lines 144. It then waits for the upstream USB entity to respond with its high speed chirp. If and when this is detected, it is sent to the downstream side 104 of the chip. While the chirps are being sent onto the downstream lines 144, the amplitude is monitored by a chirp amplitude monitor of the amplitude detectors 130. The chirp amplitude is larger than the high speed signaling levels. As soon as the chirp amplitude drops from chirp signaling levels to high speed signaling levels, this indicates that the USB downstream entity has connected its 45 Ohm resistors 125 to ground by driving the LS/FS driver 124 outputs low. The chirp amplitude monitor detects this and outputs a chirp completion signal 154 to the FMUX 118. The isolator chip mirrors the downstream USB entity behaviour to its upstream USB interface 144, by similarly connecting its 45 Ohm resistors 125 to ground by means of the LS/FS TX 124. The isolator chip is thus placed in high speed mode.

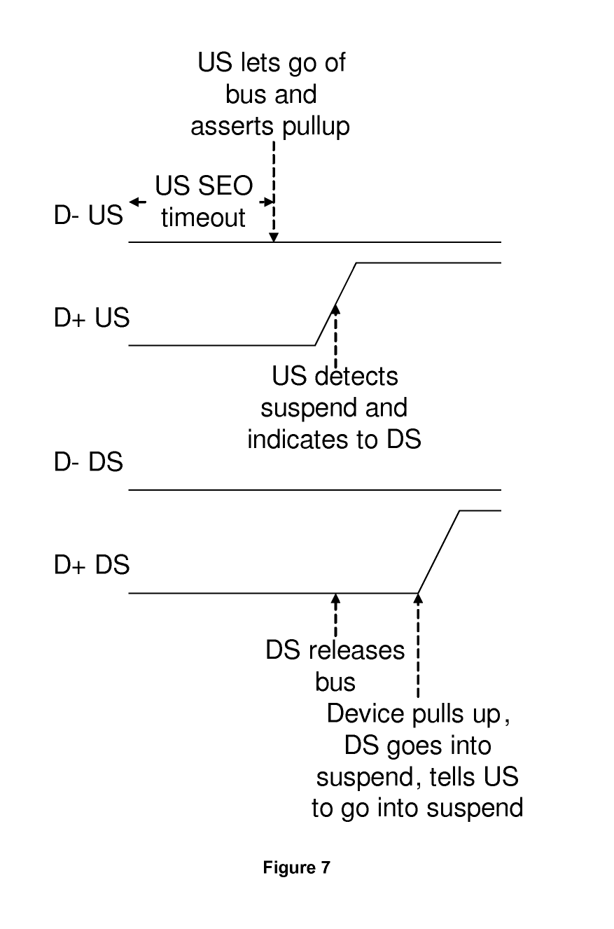

FIG. 7 is a schematic timing diagram showing various signals in the isolator during entry to suspend mode from a high speed state. In high speed mode, when the chip is required to enter suspend mode, full speed signaling conditions are resumed. To accomplish a transition to suspend, the isolator determines the length of time spent in the high speed idle state. After a defined time-out period, the isolator floats the bus 144 on the upstream side 102 (by ceasing to drive the corresponding LS/FS driver 124 to ground), and reconnects the FS pull-up resistor 108. If the upstream side 102 of the chip subsequently detects that the upstream connected USB entity has also let go of the bus 144, giving a FS idle condition, this indicates that the isolator should go into suspend mode. The downstream bus 144 is then released, and the isolator enters suspend mode.

If, after floating the upstream bus 144, the FS idle condition is not detected on the upstream bus 144 before a predefined length of time from the start of the HS idle, this indicates a host reset, so the isolator holds the FS SE0 on the downstream side 104 (drives the 45 Ohm resistors 125 to ground) to indicate reset to the downstream connected USB entity.

Wakeup signals (from suspend) are propagated through the isolator by FS/LS signaling, as defined in the USB 2.0 standard.

### USB Device Disconnects

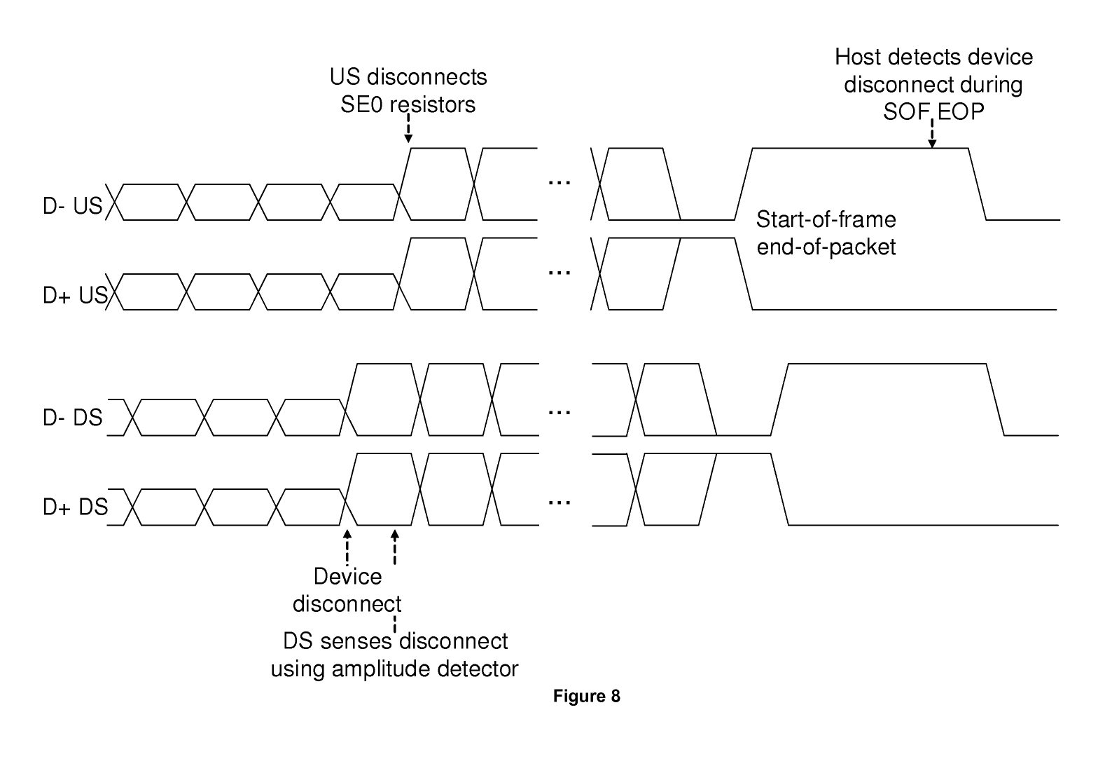

USB device disconnects are handled differently for high speed and full speed/low speed modes. An example high speed disconnect is illustrated in FIG. 8. Disconnect is detected while the DS USB port 144 is transmitting. It is driving a fixed current into the D+/D− lines 144, so that when a downstream USB entity is disconnected and thus its 45 Ohm resistors to ground are removed, the swing on the downstream data lines 144 is doubled. This is detected by a disconnect amplitude detector of the amplitude detector block 130, and a disconnect signal 152 is asserted. This signal is received by the downstream FMUX 118, which communicates the condition to the upstream side 102 of the isolator through the digital control blocks 120 and the corresponding state synchronization isolator channel 136. The upstream side then ceases to drive its 45 Ohm resistors 125 to ground (SE0), thus mimicking the condition of a USB device disconnect to the upstream connected USB entity. This upstream USB entity will detect the disconnect condition during the start-of-frame end-of-packet as specified in the USB 2.0 standard.

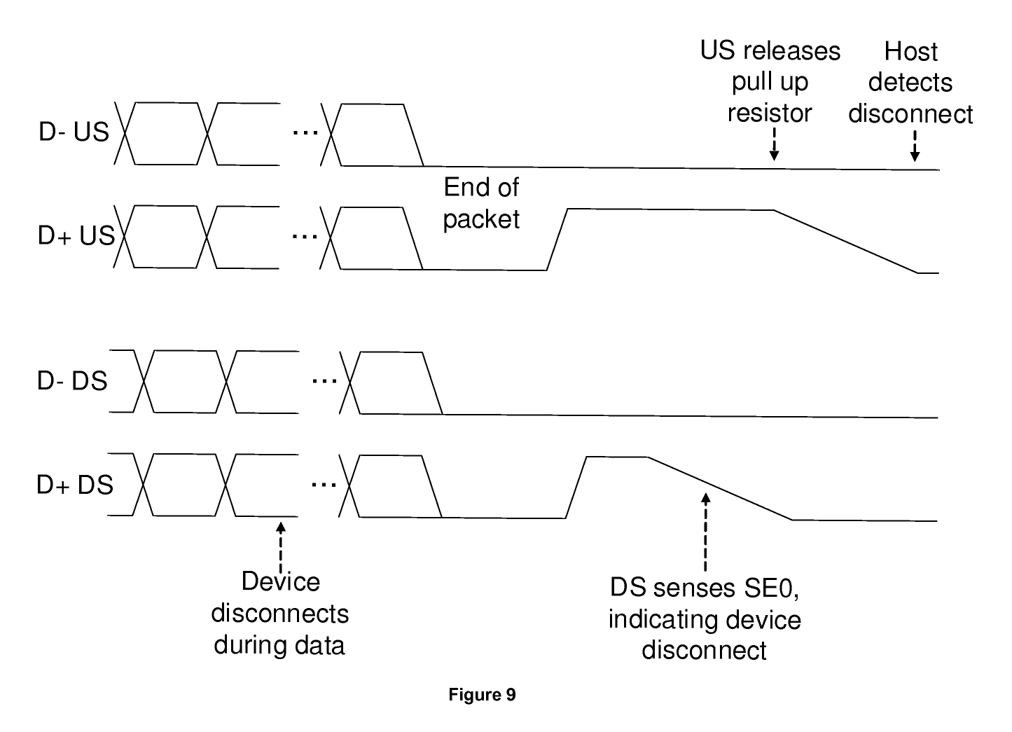

During full speed or low speed, a USB device disconnect is indicated when the downstream port 144 is not being driven, as shown in FIG. 9. If the voltage levels of both USB bus lines 144 go low (the pull-up resistor of the downstream USB entity is no longer connected), this indicates that the downstream USB entity is no longer connected. This condition is sent to the upstream side 102 of the isolator using the state synchronization isolator channel 136, and the pull-up resistor 108 on the upstream side 102 of the isolator is disconnected to mimic the USB device disconnect. The upstream USB entity will detect that the USB lines have gone low, and will thus be informed of the USB device disconnect.

### USB Upstream Entity Disconnects

If the upstream USB entity is disconnected and the isolator sees no activity on its upstream bus 144 for longer than a normal idle (or reset in high speed mode) as specified in the USB 2.0 specification, the isolator will go into suspend mode until a reconnect is indicated by one of the upstream lines 144 being pulled high.

Regardless of state and direction of data, the USB line receivers 128 are always enabled.

### Capacitive Isolator Refresh

The isolators described herein are designed to withstand voltage differentials across the isolation barrier 106 and coupling components 105, as well as providing some immunity to power surges or transients. However, a sufficiently large transient may nevertheless corrupt the data on the isolator channels. However, it is desirable that the isolator is able to maintain its state during such a transient event, or at least to have a mechanism whereby the state of the isolator channels 134, 136 can be reset to a defined state (for example, to the idle state, ready to receive the next USB packet).

In order to address the difficulty of a glitch or power surge causing a change in the data isolation channels state during this idle period when neither side is driving the isolation channel, provision is made for the state to be periodically refreshed. This refresh operation is controlled by the digital logic blocks 120, which are aware of the current state of the isolator. As shown in FIG. 10, the digital logic blocks 120 generate pulses that are applied to CMOS FETs 1002, 1004 connected to the coupling capacitors 105 to refresh the correct idle state. Usually, the inputs of the NMOS FETs 1002 are low, and the inputs of the PMOS FETs 1004 are high, and their outputs are thus in a high impedance state. When the outputs of the FETs 1002, 1004 are not in high impedance state, the inputs of the two capacitors 105 are driven to the opposite voltage to preserve differential operation. These FETs 1002, 1004 can also be used to drive the isolation channels to a pre-defined state on startup. These refresh FETs 1002, 1004 are much weaker than the FETs in the isolation channel transmitters 1006, 1008. Therefore, if a refresh pulse is asserted during a data transmission through the isolator, the transmission overwhelms the refresh pulse.

The USB protocol ensures only one side has control of the USB bus at a time. In the unlikely event that both sides of an isolation channel attempt to drive the channel at the same time, for example due to a glitch or other error, a state mismatch will soon be indicated to the digital logic blocks 120 by communication on the state synchronisation lines 136. The digital logic blocks resolve the deadlock by dropping the remaining part of the packet and putting both sides of the chip into their idle states. The USB packet affected by the glitch or error is corrupted. However, the USB protocol contains built-in error detection and the host and/or device will retransmit data as defined at the higher software levels of the USB 2.0 specification, resulting in no loss of connectivity or data to the application using the USB link.

### Jitter Reduction

USB isolators in accordance with the embodiments described above can use standard low-jitter design techniques for all the circuit blocks in the signal path. These techniques may include using fast edge rates for digital circuits, limiting the amount of supply bounce, using sufficient on-chip supply decoupling capacitance, and using CML logic in differential paths such as across the isolation barrier 106 to reduce susceptibility to common-mode noise. However, in USB 2.0 high speed mode, any random or deterministic jitter from a connected USB entity will be added to by the USB isolator chip itself, which could result in desired jitter specifications not being met. In these circumstances, an accurate timebase can be used to resynchronise the data on retransmission, and to correctly recover received bits. Low speed and full speed signaling do not require these circuits, because the jitter specifications are relaxed.

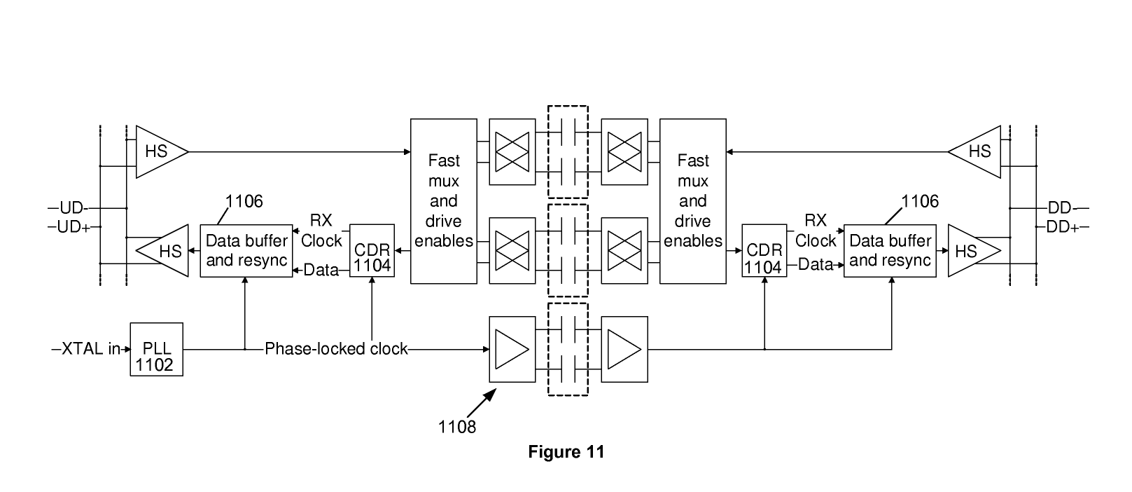

To reduce jitter in the retransmitted USB data, the USB isolator can include a phase locked loop (PLL) and clock and data recovery (CDR) circuit, as shown in the embodiment of FIG. 11. The PLL 1102, CDR 1104, and resynchronization 1106 blocks in FIG. 11 provide a low jitter output after reception and retransmission of a USB data stream, and accurate recovery of the incoming data using known clock and data recovery schemes.

In some embodiments, two crystal oscillator inputs are provided to respective sides 102, 104 of the isolator chip, with a corresponding PLL 1102 for each side. However, a more efficient scheme is to provide a crystal oscillator input and PLL 1102 on only one side of the isolator chip, as shown in FIG. 11. The phase-locked clock is then sent across an additional isolation channel 1108. A further embodiment (not shown) includes only one crystal oscillator but PLL circuits on both sides of the chip, with a detection circuit that detects which side of the isolator chip the crystal is connected to (by detecting toggling on the crystal input line at startup). This then enables the PLL 1102 on that side of the isolator chip, and disables the PLL 1102 on the other side of the chip.

The phase-locked clock is used for two purposes. First, to provide an approximate clock for a burst-mode CDR circuit 1104 to work from, when recovering incoming data. This data is then stored in a buffer 1106 to avoid overflow/underflow errors. The data is then resynchronised using the phase-locked clock generated by the PLL 1102 and is transmitted onto the USB bus 144. The disadvantages of using resynchronization of high speed signaling are (i) increased chip complexity, area, power consumption, and cost, and (ii) increased delay through the isolator chip due to the necessary transmit data buffer.

The USB isolators described herein will be useful in many applications, including medical applications, where patient monitoring equipment must be electrically isolated from the mains, and in industrial applications, where machine sensing and control circuits must be electrically isolated from control and analysis computers. The USB isolators also provide an advantage over existing USB isolators in that they simplify assembly because they will function with any combination of USB 2.0 entity speeds, including high speed data transfer at the USB 2.0 rate of 480 Mbps. This is important in current and future applications that require fast transfer of large amounts of data, such as in the medical and industrial fields. It can also be used in high throughput streaming (e.g., audio and video) applications, where electrical isolation is needed to remove noise and break potential ground loops (which cause audio hum), and, in appropriate embodiments, to reduce jitter in streamed data.

### On-The-Go and Embedded Host Functionality

Some embodiments of the invention also implement the USB On-The-Go and Embedded Host supplement of the USB 2.0 standard. While the nature of the downstream and upstream USB entities may differ, the signaling remains essentially the same and can be isolated in the ways described herein.

Many modifications will be apparent to those skilled in the art without departing from the scope of the present invention.

1. A USB isolator integrated circuit, including:
an isolation barrier disposed between an upstream portion and a downstream portion of the integrated circuit to provide galvanic isolation therebetween;
a first USB 2.0 interface configured to receive and transmit USB 2.0 compliant signals between the upstream portion of the integrated circuit and an upstream USB entity;
a second USB 2.0 interface configured to receive and transmit USB 2.0 compliant signals between the downstream portion of the integrated circuit and a downstream USB entity;
a plurality of signal coupling components configured to allow communication between the upstream portion and the downstream portion of the integrated circuit to allow the upstream USB entity and the downstream USB entity to communicate therebetween using a USB 2.0 protocol while maintaining the galvanic isolation therebetween; and
the upstream and downstream portions of the integrated circuit including respective modules configured to automatically detect a USB 2.0 speed of the upstream or downstream USB entities and responsive to said detection to automatically put the integrated circuit into a corresponding one of a plurality of USB 2.0 speed modes for communication between the upstream and downstream USB entities, the plurality of USB 2.0 speed modes including a USB low-speed mode, a USB full-speed mode, and a USB 2.0 high-speed mode.

2. The USB isolator integrated circuit of claim 1, wherein the modules include state machines respectively disposed on the upstream and downstream portions of the integrated circuit, the state machines being configured to store state information representing states of the respective portions of the integrated circuit and to synchronise the state information therebetween.

3. The USB isolator integrated circuit of claim 2, wherein the state machines are further configured to correct one or more errors in the states of the upstream and/or downstream portions of the integrated circuit.

4. The USB isolator integrated circuit of claim 2, wherein USB data is communicated between the upstream and downstream USB entities over one or more of the signal coupling components, and the state machines communicate the state information therebetween over one or more other ones of the signal coupling components.

5. The USB isolator integrated circuit of claim 4, wherein the one or more other signal coupling components communicating the state information between the upstream and downstream portions of the integrated circuit are not inline with the one or more signal coupling components over which the USB data is communicated.

6. The USB isolator integrated circuit of claim 4, wherein the one or more other signal coupling components communicating the state information are clocked independently of and slowly relative to the one or more signal coupling components over which the USB data is communicated.

7. The USB isolator integrated circuit of claim 2, wherein only one of the upstream and downstream portions of the integrated circuit includes an input from a crystal oscillator to function as a reference for a PLL, the output of which is used to resynchronize USB high-speed signaling before retransmission onto a USB bus on the corresponding portion of the integrated circuit.

8. The USB isolator integrated circuit of claim 2, wherein the upstream and downstream portions of the integrated circuit each includes a corresponding input from a corresponding crystal oscillator to function as a reference for a corresponding PLL, the output of which is used to resynchronize USB high-speed signaling before retransmission onto the corresponding USB bus on the corresponding portion of the integrated circuit.

9. The USB isolator integrated circuit of claim 1, wherein the signal coupling components are capacitive isolators that provide capacitive coupling between the upstream and downstream portions of the integrated circuit.

10. The USB isolator integrated circuit of claim 9, wherein the capacitive isolators include capacitors and capacitor charging components configured to refresh charges on the capacitors.

11. The USB isolator integrated circuit of claim 9, wherein the upstream and downstream portions of the integrated circuit are mutually spaced on a single electrically insulating die and the integrated circuit includes at least one coupling region on the die to provide capacitive coupling between the otherwise mutually isolated integrated circuit portions, the integrated circuit portions being formed by a plurality of layers on the single die, the layers including metal and dielectric layers and at least one semiconductor layer;
wherein at least one of the dielectric layers extends from the integrated circuit portions across the coupling region and at least a corresponding one of the metal layers and/or at least one semiconductor layer extends from each of the integrated circuit portions and partially into the coupling region to form one or more capacitors therein and thereby provide the capacitive coupling between the galvanically isolated integrated circuit portions.

12. The USB isolator integrated circuit of claim 1, wherein each of said upstream and downstream portions of the integrated circuit includes a corresponding input for coupling to a corresponding precision resistor to define currents for high speed USB 2.0 signaling.

13. The USB isolator integrated circuit of claim 1, wherein:
the first USB 2.0 interface is configured to receive and transmit USB 2.0 compliant signals between the upstream portion of the integrated circuit and any USB entity, including: a standard USB host, a USB Embedded Host, a USB On-The-Go device, and a USB hub; and
the second USB 2.0 interface is configured to receive and transmit USB 2.0 compliant signals between the downstream portion of the integrated circuit and any USB entity, including: a standard USB device, a USB Embedded Host, a USB On-The-Go device, and a USB hub.

14. The USB isolator integrated circuit of claim 1, wherein the modules are configured to propagate USB signals, device connects and device disconnects from one of the upstream and downstream USB entities to the other of the upstream and downstream USB entities so that the USB isolator integrated circuit is transparent to the upstream and downstream USB entities other than time delays.

15. The USB isolator integrated circuit of claim 1, wherein at least some of the signal coupling components are bi-directional signal coupling components configured to allow communication in both directions between the upstream portion and the downstream portion of the integrated circuit.

16. The USB isolator integrated circuit of claim 1, wherein the signal coupling components include first uni-directional signal coupling components configured to allow communication only from the upstream portion to the downstream portion of the integrated circuit, and second uni-directional signal coupling components configured to allow communication only from the downstream portion to the upstream portion of the integrated circuit.

17. The USB isolator integrated circuit of claim 4, wherein only one of the upstream and downstream portions of the integrated circuit includes an input from a crystal oscillator to function as a reference for a PLL, the output of which is used to resynchronize USB high-speed signaling before retransmission onto a USB bus on the corresponding portion of the integrated circuit.

18. The USB isolator integrated circuit of claim 4, wherein the upstream and downstream portions of the integrated circuit each includes a corresponding input from a corresponding crystal oscillator to function as a reference for a corresponding PLL, the output of which is used to resynchronize USB high-speed signaling before retransmission onto the corresponding USB bus on the corresponding portion of the integrated circuit.

19. The USB isolator integrated circuit of claim 6, wherein only one of the upstream and downstream portions of the integrated circuit includes an input from a crystal oscillator to function as a reference for a PLL, the output of which is used to resynchronize USB high-speed signaling before retransmission onto a USB bus on the corresponding portion of the integrated circuit.

20. The USB isolator integrated circuit of claim 6, wherein the upstream and downstream portions of the integrated circuit each includes a corresponding input from a corresponding crystal oscillator to function as a reference for a corresponding PLL, the output of which is used to resynchronize USB high-speed signaling before retransmission onto the corresponding USB bus on the corresponding portion of the integrated circuit.
